(19) United States
(12) Patent Application Publication
(10) Pub. No.: US 2026/0226758 A1
(43) Pub. Date: Aug. 6, 2026

(54) Method for controlling a construction robot, and construction robot

(71) Applicant: Hilti Aktiengesellschaft, Schaan (LI)

(72) Inventors: Peer SCHMIDT, Lindau (DE); Dario BRALLA, Buchs (CH)

(21) Appl. No.: 19/148,327

(22) PCT Filed: Jan. 5, 2024
(86) PCT No.: PCT/EP2024/050189

§ 371 Date: Jul. 16, 2025

(30) Foreign Application Priority Data
Jan. 23, 2023 (EP) 23152868.8

(51) Int. Cl. E04G 21/16; B25J 9/16; B25J 15/00; B25J 19/02

(52) U.S. Cl. CPC E04G 21/163; B25J 9/162; B25J 9/1679; B25J 9/1697; B25J 19/022; B25J 15/0019

(57) ABSTRACT

A method (1000) for controlling a construction robot (10), wherein the construction robot (10) is controlled to move to at least one work position (20) on a building element (12) with a tool (18) disposed on a manipulator of the construction robot (10), wherein the work position (20) is marked by at least one line light beam (52). The invention is characterized in that the construction robot (10) moves the manipulator and/or the tool (18) in dependence on a position of a point of impact (AP1, AP2, AP3) of the line light beam (52) on the construction robot (10).

### DESCRIPTION

The invention relates to a method for controlling a construction robot.

### SUMMARY OF THE INVENTION

A construction robot is controlled to move to at least one work position on a building element with a tool disposed on a manipulator of the construction robot, wherein the work position is marked by means of at least one line light beam. The construction robot can then perform construction work at the work position.

For this purpose, the light image drawn by the line light beam on the building element can first be recorded and evaluated using image processing in order to determine a position of the marked work position. A construction robot position and a construction robot position of the construction robot can then be determined. These different data can be combined to determine a path along which the tool can move to the work position.

However, this method fails in many cases. There are often installation elements or the like already on building elements, such as building ceilings. These can interrupt the line of sight between the construction robot and a work position disposed on the building element, meaning that the construction robot cannot pick up the light image of the marked work position. Such interfering objects, such as the installation elements mentioned, can also lead to errors in determining the position of the work position. For example, there may be confusion between a part of the line light beam that hits an interfering object and a part of the line light beam that actually marks the work position on the building element. Different heights of these different parts can lead to an apparent offset of the work position for the construction robot.

However, if the work position is not determined correctly, this can lead to construction work being carried out in the wrong position. During drilling work, for example, holes may be drilled in unsuitable positions. During chiselling work, this can lead to unintentional destruction of the building element or another nearby object.

It is an object of the present invention to provide a method by which the construction robot is enabled to reliably move to a work position on a building element marked by a line light beam with the tool. It is furthermore an object of the present invention to provide a construction robot by means of which construction work can be reliably carried out at a work position marked by a line light beam.

The present invention provides a method for controlling a construction robot, wherein the construction robot is controlled to move to at least one work position on a building element with a tool disposed on a manipulator of the construction robot, wherein the work position is marked by means of at least one line light beam, wherein the construction robot moves the manipulator and/or the tool in dependence on a position of a point of impact of the line light beam on the construction robot.

Among other things, the invention is based on the surprising idea that the line light beam, when it hits the construction robot, itself describes a straight path from the construction robot to the work position. Data on a path to the work position can therefore be obtained not only by examining the work position on the building element itself, but also by examining the line light beam, in particular away from the building element. Interference effects such as the interruption of the line of sight described above, an apparent offset due to interfering objects, etc. can be avoided or at least reduced if the line light beam is not examined in the area of the building element but in the direct vicinity of the construction robot, in particular when it hits the construction robot. As a result, a path to the work position can be determined with a very high degree of reliability by detecting the position of at least one point of impact on the construction robot.

It is therefore conceivable that the construction robot detects that the line light beam is passing the tool, i.e., that the tool does not reach the work position in its current position. The construction robot can then be configured to perform a corrective movement that aligns the tool along the line light beam again, at least with sufficient accuracy.

The tool can thus be guided along the line light beam by means of step-by-step movements until it finally reaches the work position.

As a rule, it is at least known in which direction the work position is to be expected. For example, when it comes to a work position on a building ceiling, it is known that this must be above the construction robot located on a building floor. The direction in which the line light beam is to be followed can therefore be derived from this.

The method can be used for different types of line light beams. For example, the line light beam can be a continuous light beam. It is also conceivable that the line light beam corresponds to one or more moving light points, such as those generated by a rotating laser. Alternatively or additionally, the light can be pulsed light.

Preferably, the method can be used with light in the infrared, visible or ultraviolet range. Alternatively or additionally, however, it is also conceivable to use the method with electromagnetic radiation in other frequency ranges, for example microwaves. Preferably, light sensors adapted to the particular frequency range, for example infrared sensors, light sensors suitable for visible light or UV sensors, can be used for this purpose.

The position of the point of impact can be determined in particular by means of at least one line light sensor or an area light sensor. Such a light sensor can be used to monitor an elongate area or a flat area along the construction robot with regard to the impact of the line light beam, making it easier to locate the line light beam. The line light sensor can have a width of, for example, at least 5 cm, in particular at least 28 cm. The area light sensor can have an area of at least 5 cm x 5 cm, for example. The line light sensor in particular can offer a balanced ratio of cost to monitored area.

In particular, it is conceivable to detect at least two positions of two different points of impact of the line light beam on the construction robot. This can be done already with a single area light sensor. Several light sensors, for example several line light sensors and/or area light sensors, which are preferably spaced apart from one another, can also be used for this purpose. Overall, this can open up the possibility of also determining the alignment of the line light beam.

It is conceivable to detect at least one position of a point of impact on the manipulator. For this purpose, a light sensor, for example a line light sensor, can be arranged on the manipulator and/or on the manipulator. Any necessary corrective movement can then be derived directly from the determined position of the point of impact. An additional determination of a relative position of the manipulator relative to a base, for example a mobile platform, of the construction robot can therefore be dispensed with.

The line light beam can also be used to mark a plurality of work positions. For example, a construction task can consist of carrying out several construction works along the line light beam at constant distances on the building element. For example, a construction task may consist of drilling holes in the building element at a specified distance from each other along the line light beam.

The method can be particularly suitable for such a case, as it already makes it possible in principle to follow the course of the line light beam.

In order to be able to check the distances between the individual construction works or work positions, for example, at least one second coordinate, such as a distance to the building element and/or to a second building element, can also be measured.

The construction robot used for the method can have a lifting device. The lifting device can be part of the manipulator.

In the case of a construction robot that is configured to carry out construction works on a building ceiling, it may be sufficient for the manipulator, in particular the lifting device, to have only one degree of freedom. The lifting device can, for example, be variable in length. It can be telescopic. A small number of degrees of freedom can save manufacturing costs. The manipulator can also be designed for particularly high loads.

If positions of at least two different points of impact are determined, the course of the line light beam can be determined.

This path is likewise rectilinear, at least in free space. It can therefore be provided that the lifting device of the construction robot is moved depending on the positions of at least two of the points of impact. In order to approach a work position on a building ceiling, the course of the line light beam can therefore first be determined, in particular an angle of inclination of the line light beam, for example relative to the vertical and/or relative to a surface normal of the building ceiling, can be determined by the work position. The lifting device can then be tilted until it assumes a position corresponding to the determined angle of inclination. The lifting device can then be extended in a straight line until it reaches the ceiling of the building. In this way, the tool on the manipulator can be guided parallel to at least part of the line light beam.

It can therefore be advantageous overall to tilt the lifting device relative to a vertical and/or relative to a surface normal of the building element based on the work position, depending on the positions of at least two of the points of impact.

A construction robot for carrying out construction works on a building element, comprising a portable platform, a manipulator on which a tool can be arranged and/or is arranged, and at least one light sensor, wherein the construction robot is configured to determine a position of a point of impact of a line light beam on the construction robot by means of the light sensor, also falls within the scope of the invention.

Such a construction robot offers the prerequisites for implementing the method described above.

Preferably, the construction robot can have a control unit. The control unit can have a computer. The computer may have a processor and memory in which executable program code is stored on the processor. The program code can be designed in such a way that the method is executed by the construction robot when the program code is executed on the processor.

In particular, the construction robot can be configured to determine positions of at least two different points of impact of the line light beam on the construction robot.

The construction robot can have at least one light sensor, in particular a line light sensor and/or an area light sensor. Preferably, it can have at least two light sensors in total. In particular, the construction robot can be configured to detect at least two different points of impact of the line light beam using at least two light sensors. Several light sensors can be arranged at a distance from each other. This allows the positions of points of impact to be determined from a particularly large area. The path of the line light beam can therefore be determined with particular precision.

The construction robot can have at least one rangefinder so that further data on the position of the work position can be obtained independently of the line light beam.

It is also conceivable that the construction robot is configured to carry out the method described above. For this purpose, it can be configured to record and evaluate images of the light image. The data obtained in this way can be used for error compensation in order to determine the position of the work position even more precisely and, if necessary, even more reliably.

The construction robot can be configured to carry out construction works along the line light beam on a surface of the building element, in particular identical construction works, at several work positions that are equally spaced apart from one another.

The construction robot can have a rangefinder, for example a laser rangefinder. The rangefinder can be arranged and/or aligned horizontally. The rangefinder can be configured to recognize a marking, for example a reflective surface, of a position marker. It can be set up to measure only when this marking, in particular the reflective surface, is recognized.

The construction robot can also have at least one odometric distance meter, in particular at least one radodometric sensor. Measurement data from the rangefinder can be prioritized over odometric measurement data. In particular, as long as there are no excessive deviations between the odometric measurement data and the measurement data of the rangefinder, the system accuracy can be improved by using the measured values of the rangefinder.

The portable platform can also comprise a mobile platform. To ensure adequate security against tipping, the portable platform, in particular the mobile platform, can have at least three, preferably mutually independent, driving points. In order to be able to move the portable platform, at least one, preferably at least two, of the driving points can be motor-drivable. One driving point can be a propeller, a wheel, a chain drive and/or a driving leg, for example.

The mobile platform can comprise a wheeled chassis, for example. The wheeled chassis can have three or four wheels, for example.

The portable platform can have a carrier. The manipulator can be arranged on the carrier.

The portable platform can be configured to swivel the manipulator relative to a vertical and/or to a surface normal of the building element that is to be worked on. To this end, the carrier can be arranged pivotably on the portable platform.

Maneuvering movements of the portable platform, in particular the mobile platform, can be reduced or avoided if the manipulator is pivoted until the tool reaches the work position. For this purpose, the tool, in particular with its longitudinal axis, can be oriented with an angle of incidence obliquely to the surface normal of the building element at the work position.

By pivoting the carrier and/or the manipulator, any unevenness in the surface on which the construction robot is located can also be compensated for.

The manipulator can have a machine tool at its free end. The tool can be accommodated in the machine tool.

The manipulator can also comprise a lifting device. In particular, the manioulator can be formed as a lifting device. The lifting device can be variable in length, in particular telescopic. Such a manipulator can be particularly suitable for working on building ceilings.

The construction robot may be suitable for use with different types of machine tools and tools.

Examples of tools can be drilling tools, especially for hammer drilling in masonry, steel drilling tools or wood drilling tools, chiselling tools or setting tools. Setting tools can be, for example, tools for setting, in particular for setting fastening elements such as screws, nails, anchors or dowels. It is also conceivable that the tool is a marking tool, e.g. a paint spray nozzle. It is also conceivable that the tool is a monitoring tool and/or a measuring tool, e.g. it can comprise a rangefinder and/or a camera.

As with the tools, the machine tools can be power drills, in particular hammer drills, power chisels, setting devices, e.g. direct setting devices for setting nails, power screwdrivers, such as drivers with or without impact, or the like.

To control one or more, preferably all, of the above-described functionalities of the construction robot, the construction robot can have a control computer.

The control computer can have a processor, a memory unit and a program code that can be executed by the processor. The processor may have one or more sub-processors. The program code can be configured, when executed on the processor, to implement one or more of the functionalities, in particular all of the functionalities, by controlling the corresponding elements of the construction robot.

In particular, it is conceivable that the construction robot, in particular a program code of a control computer of the construction robot, is configured to carry out the above-described method by controlling further elements of the construction robot.

The construction robot can have an acceleration and/or inclination sensor, e.g. an inertial measurement unit, referred to below as “IMU”. The acceleration sensor and/or the inclination sensor can be arranged on the mobile platform. Alternatively or in addition, they can also be arranged on the lifting device and/or on the machine tool.

The construction robot may be formed for performing construction works on a building construction site and/or a civil engineering construction site.

The building element can comprise, for example, a building ceiling, a building wall and/or a building floor.

### BRIEF DESCRIPTION OF THE DRAWINGS

Further features and advantages of the invention are apparent from the following detailed description of exemplary embodiments of the invention, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and will be explained in detail in the following description.

In the figures:

FIG. 1 shows a construction robot and a building element in an oblique perspective view,

FIGS. 2, 3 and 4 show the construction robot according to FIG. 1 in a view from the side, in a view from above and in a view from below,

FIG. 5 shows a schematic illustration of an angle of incidence of the construction robot with respect to the building element,

FIG. 6 shows a schematic illustration of a line laser that marks several work positions by means of a line light beam, wherein the line light beam is detected by the construction robot,

FIG. 7 shows the construction robot illuminated by the line light beam in a view from the front, and

FIG. 8 shows a method for controlling a construction robot.

### DETAILED DESCRIPTION

In the description of the figures that follows, comprehension is facilitated by use of the same reference signs in each case for identical or functionally corresponding elements throughout the various figures.

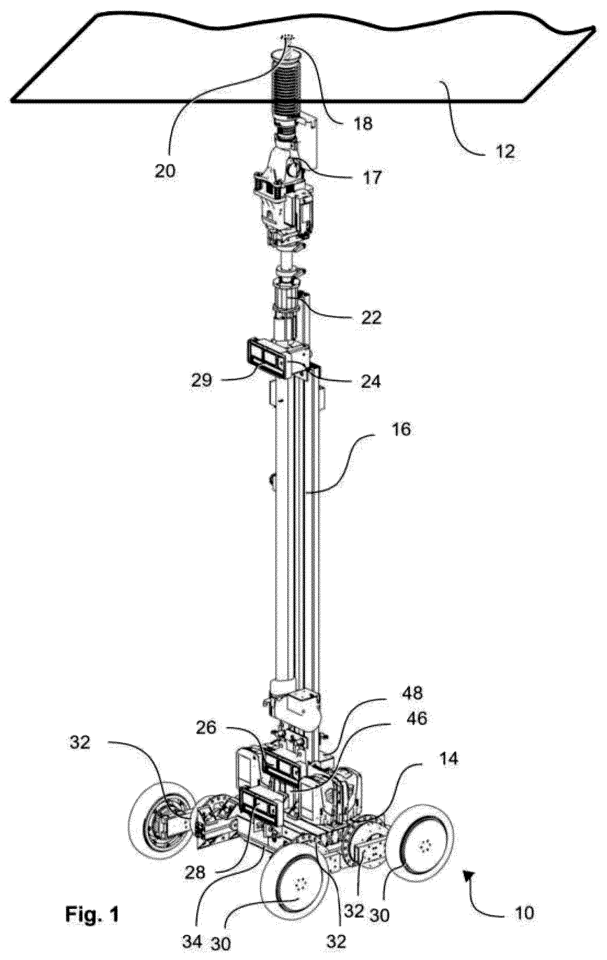

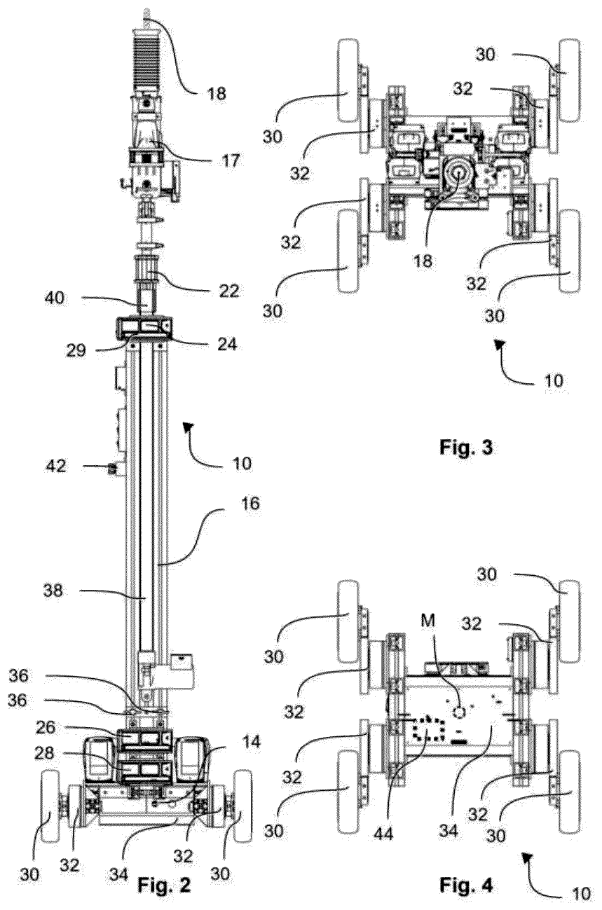

FIG. 1 shows a construction robot 10 for performing work on a building element 12. FIG. 2 shows a side view of the construction robot 10. FIG. 3 and FIG. 4 show a view of the construction robot 10 from above and from below, respectively.

The construction robot 10 comprises a portable platform in the form of a mobile platform 14, a manipulator in the form of a lifting device 16 and a machine tool 17 arranged on the lifting device 16. A tool 18 is received in the power tool 17. The tool 18 makes contact with a work position 20 on the building element 12. Situated along the lifting device 16 are a prism 22 and a first line light sensor 24, a second line light sensor 26, and a third line light sensor 28. The construction robot 10 furthermore comprises a control computer 46. Furthermore, the construction robot has a laser rangefinder 48 on a rear side, in particular on the side opposite the line light sensors 26, 28.

The power tool 17 is configured as a hammer drill. The tool 18 is a concrete drill.

The building element 12 is a building ceiling consisting of reinforced concrete.

The construction robot 10 is configured to drill a hole into the building element 12 designed as a building ceiling at the work position 20.

The line light sensors 24, 26, 28 are configured to detect the position of incident light beams or light spots. For this purpose they each have a light-sensitive sensor line 29. To simplify the illustration, only one of the sensor lines 29 is provided with a reference sign in FIG. 1. The light-sensitive sensor lines 29 can have a width of, for example, 10 cm. Matrices of light-sensitive individual sensors extend across the width of the sensor lines 29.

The first line light sensor 24 and the second line light sensor 26 are arranged in a vertically offset manner one above the other. The third line light sensor 28 is arranged obliquely forwards below the second line light sensor 26.

As an alternative or in addition, the prism 22, in particular in combination with a total station, can be used to determine a position and/or orientation of the construction robot 10 and, in particular, of the tool 18.

The mobile platform 14 has four driving points 30, of which only three driving points 30 can be seen in FIG. 1 for presentation reasons. The driving points 30 have wheels. The wheels are directional wheels. It is not necessary, but it is conceivable, that the wheels are omnidirectional wheels.

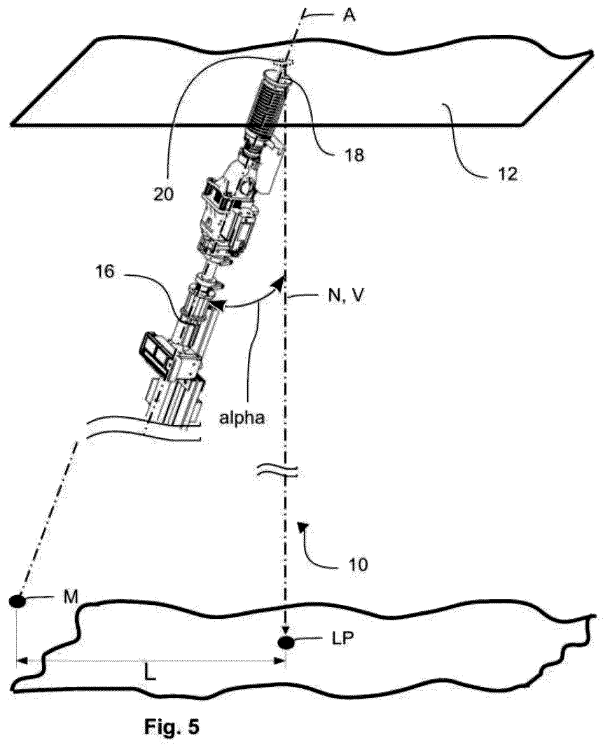

Each of the driving points 30 has a height adjuster 32. The height adjusters 32 engage on a support 34. The lifting device 16 is arranged on the support 34. By means of the height adjusters 32 it is thus possible to pivot the support 34. By pivoting the support 34, it is thus also possible to pivot the lifting device 16 and the power tool 17 connected to it, and hence the tool 18. As will be explained in greater detail below in connection with FIG. 5, the construction robot 10 can thus pivot the lifting device 16 and hence the power tool 17 with its tool 18 relative to a surface normal of the building element 12 by means of the height adjusters 32 of the mobile platform 14.

The height adjusters 32 are of self-locking design. For this purpose, they may have a worm gear mechanism. Thus, the height adjusters 32 and hence an angle of inclination of the mobile platform 14 are adjusted only when the worm gear mechanisms are moved, e.g. by means of a servomotor.

The lifting device 16 has a single degree of freedom. In particular, it is of variable length. As can be seen, in particular, from FIG. 2, fixing levers 36 can be used to release a lower part 38 of the lifting device 16, to move it manually along the rest of the lifting device 16, and then to fix it on the rest of the lifting device 16 again. In this way, the construction robot 10 can first of all be set manually roughly to a first length or height, from which the construction robot 10 can automatically extend an upper part 40 of the lifting device 16 as required, in particular in an electrically driven manner, until the tool 18 reaches the work position 20 or, where applicable, penetrates into the building element 12 at this position.

Overall, the construction robot 10 is dimensioned in such a way that its total weight is less than 50 kg. If, as illustrated in FIG. 1 and FIG. 2 for example, the construction robot 10 is retracted as far as a minimum length, it has a height of less than 1.5 m, for example. The mobile platform 14 occupies an area of less than 60×60 cm. As a result of this too, the construction robot 10 can be carried without problems by a construction worker and can be transferred within conventional buildings, e.g. from one room to another.

The construction robot 10 furthermore has an operating mode selector switch 42 (see especially FIG. 2). The operating mode selector switch 42 makes it possible to operate the construction robot 10 in a first operating mode, in which the robot automatically approaches the work position 20 with its tool 18. In a second operating mode, the construction robot 10 can be controlled by manual guidance. In the second operating mode, it is possible in particular for the lifting device 16 to be pivoted manually in a desired direction by appropriately directed pressure.

FIG. 4 schematically depicts an IMU 44. The IMU 44 is located on the support 34 and is therefore not visible in the view of the construction robot 10 from below in FIG. 4.

FIG. 4 furthermore shows a central point M of the support 34.

The construction robot 10 is configured to measure accelerations and angles of inclination of the support 34 with respect to the horizontal by means of the IMU 44. In this way, it is possible to detect irregularities in the underlying surface, for example, by means of the IMU 44. The construction robot 10 is furthermore configured to compensate such angles of inclination and/or irregularities, in particular during a movement of the mobile platform 14, by means of the height adjusters 32, and therefore the construction robot 10 is continuously protected from falling over.

FIG. 5 will be used to explain in greater detail how the tool 18 is aligned obliquely to a surface normal N of the building element 12 upon which work is to be performed, with its longitudinal axis A at an angle of incidence alpha.

For this purpose, by way of simplification, FIG. 5 shows part of the lifting device 16. In particular, FIG. 5 shows that the tool 18 makes contact obliquely with the building element 12 at the work position 20.

This gives the angle of incidence alpha, which, in particular, differs from zero, between the longitudinal axis A of the tool 18 and the surface normal N through the work position 20.

Since, in this case, the building element 12 extends horizontally, corresponding to a building ceiling, the surface normal N also extends parallel to a vertical V in the exemplary embodiment illustrated.

Here, for presentation reasons, the angle of incidence alpha is considerably exaggerated in FIG. 5. In an actual use case, the angle of incidence alpha can be less than 10°, in particular less than 5°, particularly preferably less than 1°, and, for example, more than 0.1°.

It can be seen that the oblique positioning of the tool 18 in accordance with the angle of incidence alpha results in the central point M of the carrier 34 (see FIG. 2) being at a horizontal distance L from a plumb point LP obtained from the perpendicular dropped from the work position 20 to the underlying surface. As a result, the central point M is likewise at the horizontal distance L from the work position 20.

Thus, the construction robot 10 is configured to perform a construction task, in this case drilling a hole, at the work position 20, even if the mobile platform 14, in particular the central point M, is not vertically below the work position 20. This eliminates the task of manoeuvring the mobile platform 14 in an appropriate manner to bring the central point M vertically below the work position 20. It is evident that it is thereby possible to reach even work positions 20 which it would otherwise be impossible to reach for lack of free space for the mobile platform 14. As a result, edge regions of the building element 12 in particular can be reached for the first time or at least more easily.

In the second operating mode, i.e. the manual operating mode, the angle of incidence can be set by manual guidance of the lifting device 16. In particular, the lifting device 16 can be pivoted by pressure on the latter. Here, the construction robot 10 is configured to limit a maximum permitted deflection and thus the maximum achievable angle of incidence alpha to such an extent that, in this operating mode too, the construction robot 10 cannot fall over at any time.

In both operating modes, the construction robot 10 is configured to set or support the respectively achieved inclination of the lifting device 16 and hence of the angle of incidence alpha by follow-up adjustment of the height adjusters 32. In the second operating mode, this has the effect, for example, that a manually set inclination of the lifting device 16 is maintained after the lifting device 16 is released. Thus, the user can approach the work position 20 with the tool 18 by extending the lifting device 16, e.g. under control by way of a remote control (not shown).

By means of the three line light sensors 24, 26, 28, the profile of a line light beam that indicates the work position 20, e.g. a correspondingly aligned laser beam, can be detected. From the detected profile of the line light beam it is possible to infer the position of the work position 20. If it is known, for example, that the line light beam is aligned in a precisely vertical manner, it is possible, as an alternative or in addition, to use the three line light sensors 24, 26, 28 to determine an angle of inclination of the lifting device 16.

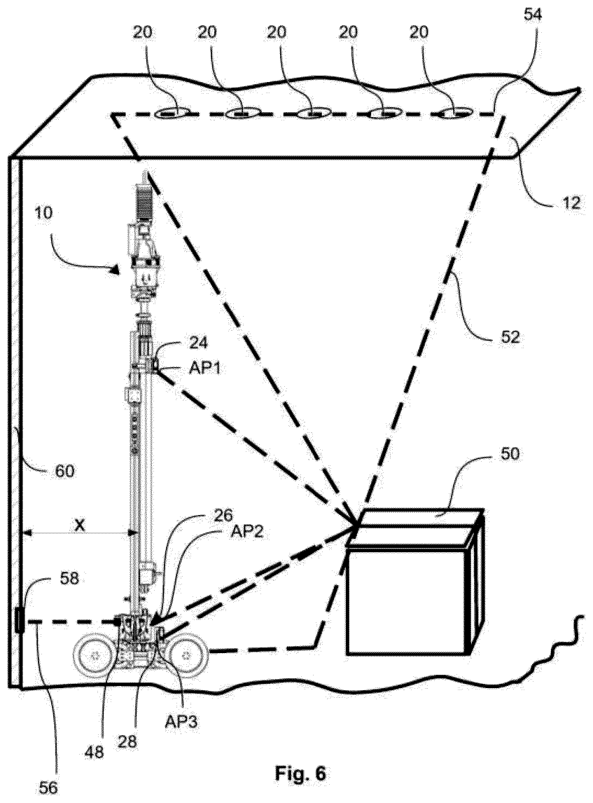

To this end, FIG. 6 shows a schematic representation of a line laser 50, which marks the position of several work positions 20 on the building element 12, spaced apart from one another at a predefined, constant distance, by means of a line light beam 52. The line laser 50 is a continuous light laser. The line light beam 52 is emitted from the line laser 50 with a beam angle of 180°, for example. It thus marks a continuous line 54 along the building element 12.

At three points of impact AP1, AP2 and AP3, the line light beam 52 strikes the line light sensors 24, 26, 28 and in particular their respective sensor lines 29 (see FIG. 1).

With its laser rangefinder 48, the construction robot 10 uses a measuring beam 56 to measure a second coordinate x to a position marker 58. For this purpose, the position marker 58 is in the form of a reflector. It is fixed to a wall 60.

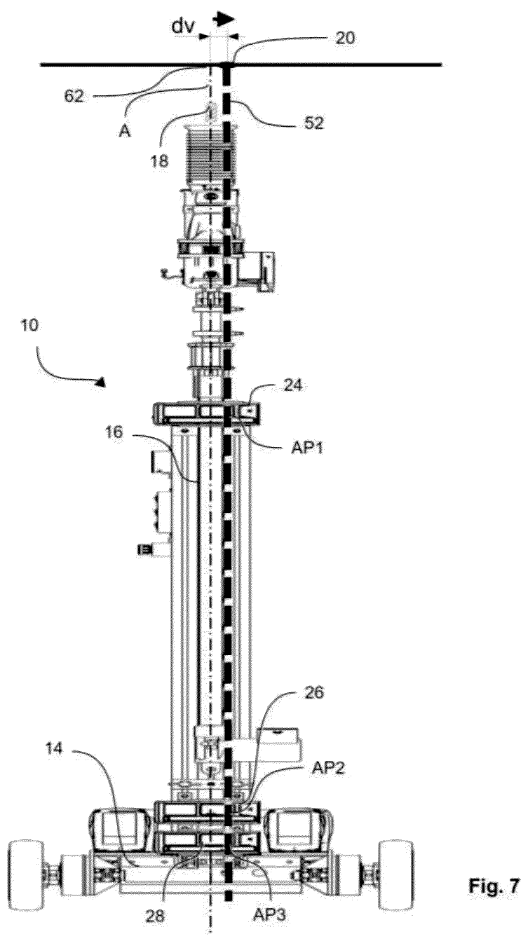

FIG. 7 shows the construction robot 10 in the situation according to FIG. 6 in a view from the front.

It can be seen that the line light beam 52 is offset from the longitudinal axis A of the tool 18 by an offset distance dv. The tool 18 is thus aligned with a target point 62 on the building element 12 that is at a distance from the working point 20.

The line light beam 52 strikes the line light sensors 24, 26 and 28 at points of impact AP1, AP2, AP3.

In the example shown in FIG. 7, the lifting device 16 is aligned vertically so that the longitudinal axis A runs parallel to the line light beam 52, which is likewise aligned vertically.

Therefore, the distances of the points of impact AP1, AP2 and AP3 from the longitudinal axis A correspond to the offset distance dv in this example. If the line light beam 52 is not parallel to the longitudinal axis A, different distances would result on the individual line light sensors 24, 26, 28, so that an inclination of the longitudinal axis relative to the line light beam 52 can be inferred from these differences.

The construction robot 10 measures these distances of the points of impact AP1, AP2 and AP3 from the longitudinal axis A and uses them to determine the offset distance dv. From this, the construction robot 10 then determines the angle of incidence alpha (see FIG. 5) according to which the lifting device 16 and thus the tool 18 must be swiveled along the direction marked with an arrow in FIG. 7 so that the tool 18 can move to the work position 20.

As described in connection with FIG. 5, the construction robot 10 then swivels the lifting device 16 to compensate for the determined angle of incidence alpha in order to compensate for the offset distance dv and to align the tool 18 with the point of impact of the line light beam 52 on the building element 12 and thus with one of the work positions 20.

The second coordinate x can be used to determine the position of the tool 18 along the line 54.

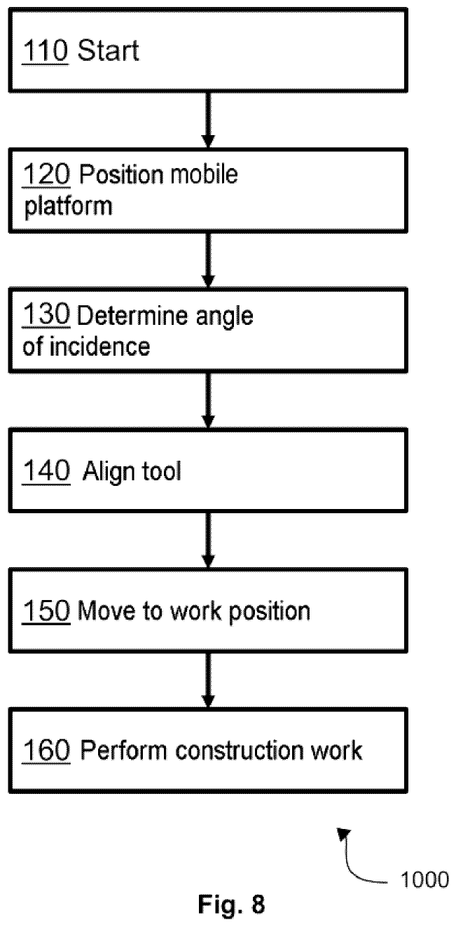

FIG. 8 shows a method 1000 for controlling a construction robot.

To explain the method 1000, reference is made to the above-described FIGS. 1 to 7 and the reference signs introduced there.

The method 1000 is likewise illustrated using the example of drilling holes at the work positions 20 of the building element 12 by means of a construction robot, e.g. the construction robot 10.

In a start phase 110, the construction robot 10 moves into the beam path of the line light beam 52 using its mobile platform 14 so that the line light beam strikes the line light sensors 24, 26, 28 at the points of impact AP1, AP2, AP3. It moves the mobile platform 14 until the laser rangefinder 48 detects and recognizes the position marker 58 with its measuring beam 56.

In a phase 120, the mobile platform 14 moves along the line light beam 52 until the second coordinate x corresponds to the next work position 20 where work is to be performed. The movement of the mobile platform 14 takes place while continuously checking the points of impact AP1, AP2, AP3 and, if necessary, corresponding corrective movements, so that the line light beam 52 does not drift away from the sensor lines 29.

As described in connection with FIG. 7, the construction robot 10 determines the offset distance dv and the required angle of incidence alpha in a phase 130.

Subsequently, in a phase 140, the construction robot 10 swivels its lifting device 16 according to the determined angle of incidence alpha in order to align the tool 18 to the next work position 20 to be machined, as described in connection with FIG. 5. Thus, the construction robot 10 moves the tool 18 in dependence on the positions of the points of impact AP1, AP2 and AP3 of the line light beam 52 on the construction robot 10. In particular, the construction robot 10 thus moves the tool 18 in dependence on the distances of the points of impact AP1, AP2, AP3 from the longitudinal axis A.

The construction robot 10 then extends the lifting device 16 in a phase 150 in order to move the tool 18 to this work position 20.

As soon as the tool 18 has reached this next work position 20 where work is to be performed, it carries out the desired construction work in a phase 160.

According to the example taken as a basis here, the power tool 17, in particular, is activated, with the result that the tool 18 begins to drill a hole at the work position 20. For drilling, the lifting device 16 is adjusted according to the progress of the drilling.

As soon as the tool 18 has drilled the hole to the desired depth, the lifting device 16 is at least partially retracted again in order to withdraw the tool 18 from the hole.

The machine tool 17 is then deactivated.

If there are additional work positions 20 at which work is to be performed, the method 1000 can be repeated at a shortened interval, beginning in phase 120, i.e., detection of the relative position.

Once all construction works have been performed at all work positions 20 where work is to be performed, the method 1000 can be terminated.

### LIST OF REFERENCE SIGNS

10 Construction robot
12 Building element
14 Mobile platform
16 Lifting device
17 Power tool
18 Tool
20 Work position
22 Prism
24 Line light sensor
26 Line light sensor
28 Line light sensor
29 Sensor line
30 Driving point
32 Height adjuster
34 Support
36 Fixing lever
38 Lower part
40 Upper part
42 Operating mode selector switch
44 IMU
46 Control computer
48 Laser rangefinder
50 Line-laser
52 Line light beam
54 Line
56 Measuring beam
58 Position marker
60 Wall
62 Destination
110 Start phase
120 Phase
130 Phase
140 Phase
150 Phase
160 Phase
1000 Method
A Longitudinal axis
AP1 Point of impact
AP2 Point of impact
AP3 Point of impact
L Distance
LP Plumb point
M Central point
N Surface normal
V Vertical
alpha Angle of incidence
dv Offset distance
X Second coordinate

What is claimed is:

1-10. (canceled)

11. A method for controlling a construction robot, the method comprising:
controlling the construction robot to move to at least one work position on a building element with a tool disposed on a manipulator of the construction robot, the work position being marked by at least one line light beam; and
the construction robot moving the manipulator or the tool in dependence on a position of at least one point of impact of the line light beam on the construction robot.

12. The method as recited in claim 11 wherein the position of the point of impact is determined via at least one line light sensor or an area light sensor.

13. The method as recited in claim 11 wherein the at least one point of impact includes two different points of impact on the construction robot.

14. The method as recited in claim 11 wherein the position of the point of impact is detected on the manipulator.

15. The method as recited in claim 11 wherein, in addition, at least one second coordinate is measured.

16. The method as recited in claim 15 wherein the second coordinate is a distance to the building element or to a second building element.

17. The method as recited in claim 13 wherein the manipulator of the construction robot is pivoted depending on the positions of the at least two of the points of contact.

18. The method as recited in claim 13 wherein, depending on the positions of the at least two of the points of contact, the manipulator is set at an incline relative to a vertical or relative to a surface normal of the building element based on the work position.

19. A construction robot comprising:
a portable platform;
a manipulator, a tool arrangeable on the manipulator;
at least one light sensor; and
the construction robot configured to determine a position of at least one point of impact of a line light beam on the construction robot via the light sensor.

20. The construction robot as recited in claim 19 wherein the portable platform the is a mobile platform and the manipulator is a lift.

21. The construction robot as recited in claim 19 wherein the construction robot is configured to determine positions of at least two different points of contact of the at least one point of impact.

22. The construction robot as recited in claim 19 wherein the at least one light sensor includes least two line light sensors or area light sensors.

23. The construction robot as recited in claim 22 wherein the at least one light sensor numbers exactly three light sensors.
